(19) United States
(12) Patent Application Publication
(10) Pub. No.: US 2013/0147593 A1
(43) Pub. Date: Jun. 13, 2013

(54) ELECTRONIC COMPONENT AND METHOD FOR PRODUCING THE SAME

(71) Applicant: MURATA MANUFACTURING CO., LTD., Kyoto (JP)

(72) Inventor: Kaoru TACHIBANA, Nagaokakyo-shi (JP)

(73) Assignee: MURATA MANUFACTURING CO., LTD., Kyoto (JP)

(21) Appl. No.: 13/766,498

(22) Filed: Feb. 13, 2013

Related U.S. Application Data
(63) Continuation of application No. PCT/JP2011/061326, filed on May 17, 2011.

(30) Foreign Application Priority Data
Aug. 18, 2010 (JP) 2010-183094

(51) Int. Cl. H01F 5/00; H01F 41/00

(52) U.S. Cl. CPC H01F 5/003; H01F 41/00
USPC 336/200; 29/602.1

(57) ABSTRACT

A multilayer body includes a plurality of insulator layers that are stacked together and has top and bottom surfaces that oppose each other in a stacking direction and side surfaces that connect the top and bottom surfaces to each other. A coil is incorporated in the multilayer body. A connecting conductor is provided on the top surface of the multilayer body so as not to be in contact with the side surfaces of the multilayer body. An outer electrode is provided on the top surface of the multilayer body so as to cover the connecting conductor. A via-hole conductor connects an end portion of the coil and the connecting conductor to each other and extends through at least one of the insulator layers in the stacking direction.

### CROSS REFERENCE TO RELATED APPLICATIONS

The present application is a continuation of International Application No. PCT/JP2011/061326, filed May 17, 2011, which claims priority claims priority to Japanese Patent Application No. 2010-183094 filed on Aug. 18, 2010, the entire contents of each of these applications being incorporated herein by reference in their entirety.

### TECHNICAL FIELD

The technical field relates to electronic components and methods for producing the electronic components, and more particularly, to an electronic component including a coil and outer electrodes and a method for producing the electronic component.

### BACKGROUND

A multilayer inductor described in Japanese Unexamined Patent Application Publication No. 9-129447 (hereinafter referred to as Patent Document 1), for example, is known as an electronic component of the related art. FIG. 4A is a perspective view of a multilayer inductor 500 described in Patent Document 1. FIG. 4B is an exploded perspective view of a multilayer body 503 included in the multilayer inductor 500 described in Patent Document 1.

As illustrated in FIGS. 4A and 4B, the multilayer inductor 500 includes the multilayer body 503, a coil 507, outer electrodes 509a and 509b, and connecting conductors 511a and 511b.

As illustrated in FIG. 4B, the multilayer body 503 is formed by stacking a plurality of rectangular insulator layers 517 together and has a rectangular parallelepiped shape. As illustrated in FIG. 4A, the coil 507 is incorporated in the multilayer body 503 and has a helical shape whose central axis extends in the stacking direction of the insulator layers 517. The coil 507 includes a plurality of coil conductors 513 that are each provided on a respective one of the insulator layers 517 and via-hole conductors 505 that extend through the insulator layers 517 in the stacking direction. The coil 507 has end portions 507a and 507b at both ends thereof.

The outer electrodes 509a and 509b are provided on surfaces (hereinafter referred to as end surfaces) located at both ends of the multilayer body 503 in the stacking direction. The outer electrode 509a is connected to the end portion 507a by a connecting conductor 511a, and the outer electrode 509b is connected to the end portion 507b by a connecting conductor 511b. Each of the connecting conductors 511a and 511b is formed by connecting a plurality of via-hole conductors.

As illustrated in FIG. 4A, the multilayer inductor 500 is used while being mounted on a printed wiring board 515. The printed wiring board 515 is a circuit board on which the multilayer inductor 500 is mounted. A plane on which the multilayer body 503 faces the printed wiring board 515 when the multilayer inductor 500 is mounted on the printed wiring board 515 is defined as a mounting plane X1. In this state, the central axis of the coil 507 is parallel to the mounting plane X1.

In the above-described multilayer inductor 500, since the central axis of the coil 507 is parallel to the mounting plane X1, the direction of magnetic flux generated by the coil 507 is also parallel to the mounting plane X1. Therefore, even when the multilayer inductor 500 is mounted on the printed wiring board 515, reduction in self-inductance and Q-factor can be suppressed.

### SUMMARY

The present disclosure provides an electronic component having a connecting conductor configuration that can increase connection reliability between a coil and an outer electrode of the electronic component.

An electronic component according to an aspect of the disclosure includes a multilayer body having first and second outermost surfaces and including a plurality of insulator layers that are stacked together and having first and second surfaces that oppose each other in a stacking direction and side surfaces that connect the first and second surfaces to each other. The multilayer body includes a coil, a first connecting conductor provided on the first outermost surface of the multilayer body and not in contact with the side surfaces of the multilayer body, a first outer electrode provided on the first outermost surface of the multilayer body and covering the first connecting conductor, and a first via-hole conductor connecting one end portion of the coil and the first connecting conductor to each other and extending through at least one of the insulator layers in the stacking direction.

A method for producing the above electronic component according to another aspect of the present disclosure includes preparing the insulator layers, forming the first via-hole conductor and a second via-hole conductor in the insulator layers, forming coil conductors and the first connecting conductor on the insulator layers. The method includes stacking the insulator layers in or on which the first via-hole conductor, the second via-hole conductor, the coil conductors, and the first connecting conductor are formed to form the multilayer body, and forming the first outer electrode on the multilayer body.

### BRIEF DESCRIPTION OF THE DRAWINGS

FIG. 1 is an external perspective view of an electronic component according to an exemplary embodiment.

FIG. 2 is an exploded perspective view of a multilayer body included in the electronic component shown in FIG. 1.

FIG. 3 is an exploded perspective view of a multilayer body included in an electronic component according to an exemplary modification.

FIG. 4A is a perspective view of a multilayer inductor described in Patent Document 1.

FIG. 4B is an exploded perspective view of a multilayer body included in the multilayer inductor described in Patent Document 1.

### DETAILED DESCRIPTION

The inventor realized the following with respect to the multilayer inductor 500 described above in Patent Document 1. The end portion 507a and the outer electrode 509a are connected to each other by the connecting conductor 511a. Therefore, the coil 507 and the outer electrode 509a are connected to each other only by the connecting conductor 511a, which is exposed at an end surface of the multilayer body 503. Since the contact area between the connecting conductor 511a and the outer electrode 509a is small, in the multilayer inductor 500, reliability of electrical connection between the coil 507 and the outer electrode 509a is not sufficient.

An electronic component according to an exemplary embodiment that can address the above shortcomings will be described with reference to the drawings.

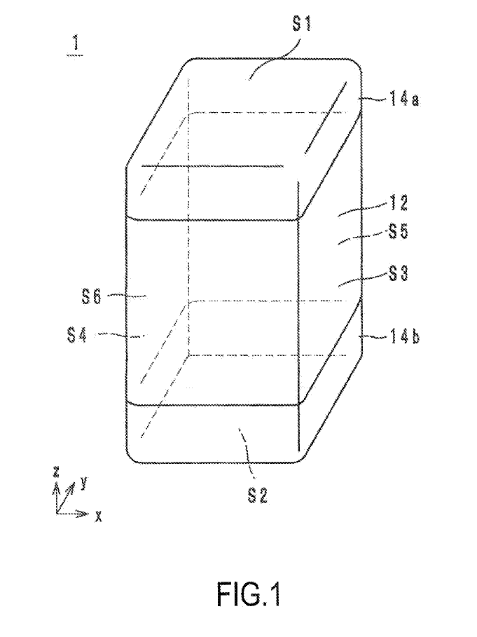

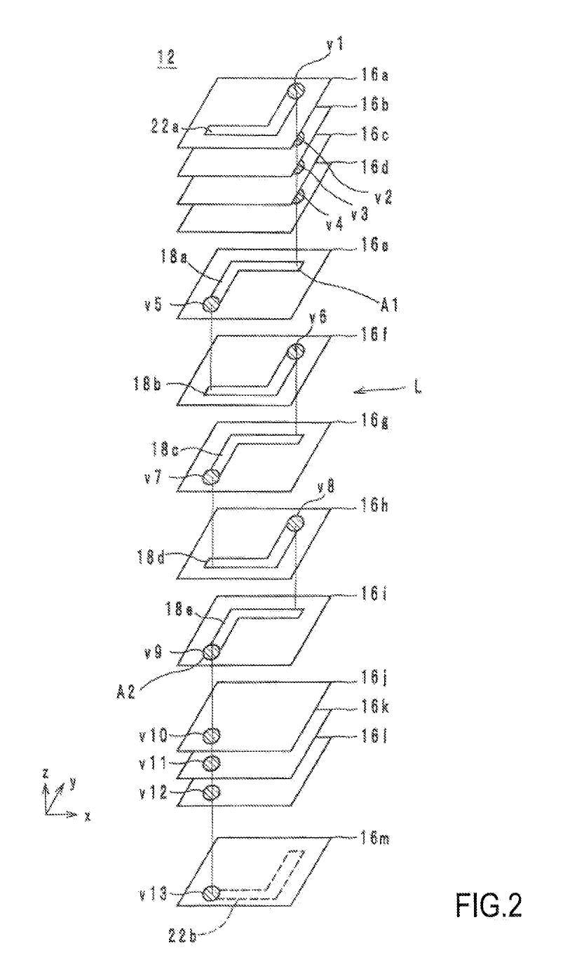

The structure of an electronic component according to an exemplary embodiment will now be described with reference to FIGS. 1 and 2 of the drawings. FIG. 1 is an external perspective view of an exemplary electronic component 1. FIG. 2 is an exploded perspective view of a multilayer body 12 included in the electronic component 1.

In the following description, the stacking direction of the multilayer body 12 of the electronic component 1 illustrated in FIG. 1 is defined as a z-axis direction. Directions along two sides of a surface of the multilayer body 12 on the positive side in the z-axis direction are defined as an x-axis direction and a y-axis direction. The x-axis direction, the y-axis direction, and the z-axis direction are orthogonal to one another. The surface of the multilayer body 12 on the positive side in the z-axis direction is referred to as a top surface S1. A surface of the multilayer body 12 on the negative side in the z-axis direction is referred to as a bottom surface S2. The bottom surface S2 opposes the top surface S1 in the z-axis direction. Surfaces of the multilayer body 12 that connect the top surface S1 and the bottom surface S2 to each other are referred to as side surfaces S3 to S6. The side surface S3 is a surface on the positive side in the x-axis direction. The side surface S4 is a surface on the negative side in the x-axis direction. The side surface S5 is a surface on the positive side in the y-axis direction. The side surface S6 is a surface on the negative side in the y-axis direction. It is to be understood that the above designations of orientation (e.g., “top,” “bottom,” “front,” “back,” and “x-,” “y-,” and “z-axis” directions) are made herein for the convenience of explaining the embodiments shown in the figures, and that other orientations can be arbitrarily defined.

Referring to FIGS. 1 and 2, the electronic component 1 includes the multilayer body 12, outer electrodes 14a and 14b, a coil L (not illustrated in FIG. 1), connecting conductors 22a and 22b, and via-hole conductors v (v1 to v4 and v9 to v13).

The multilayer body 12 has a rectangular parallelepiped shape, and has a coil L incorporated therein. As illustrated in FIG. 2, the multilayer body 12 is formed by stacking a plurality of insulator layers 16a to 16m, which are sometimes collectively referred to herein as insulator layers 16, in that order from the positive side toward the negative side in the z-axis direction. The insulator layers 16 are rectangular layers made of a magnetic material (e.g., Ni—Cu—Zn ferrite). Here, “magnetic material” means a material that functions as a magnetic material in the temperature range of −55° C. or more and 125° C. or less. In the following description, a surface of each insulator layer 16 on the positive side in the z-axis direction is referred to as a front surface, and a surface of each insulator layer 16 on the negative side in the z-axis direction is referred to as a back surface.

The coil L is incorporated in the multilayer body 12. As illustrated in FIG. 2, the coil L is formed of coil conductors 18a to 18e, which are sometimes collectively referred to herein as coil conductors 18, and via-hole conductors v5 to v8, and has a helical shape that winds counterclockwise from the positive side toward the negative side in the z-axis direction. An end portion of the coil L on the positive side in the z-axis direction is defined as an end portion Al, and an end portion of the coil L on the negative side in the z-axis direction is defined as an end portion A2. The central axis of the coil L extends in the stacking direction.

As illustrated in FIG. 2, the coil conductors 18a to 18e are L-shaped linear conductors provided on the front surfaces of the insulator layers 16e to 16i, respectively. Specifically, the number of turns of each of the coil conductors 18a to 18e is ½, and each of the coil conductors 18a to 18e extends along two adjacent sides of the corresponding one of the insulator layers 16e to 16i.

In the following description, in plan view viewed from the positive side in the z-axis direction, an upstream end of each coil conductor 18 in the counterclockwise direction is defined as an upstream end, and a downstream end of each coil conductor 18 in the counterclockwise direction is defined as a downstream end. The number of turns of each coil conductor 18 is not limited to ½. The number of turns of each coil conductor 18 can instead be a different value, for example, ¾ or ⅞. The upstream end of the coil conductor 18a (that is, the upstream end of the coil L) is the end portion A1, and the downstream end of the coil conductor 18e (that is, the downstream end of the coil L) is the end portion A2.

The via-hole conductor v5 extends through the insulator layer 16e in the z-axis direction, and is connected to the downstream end of the coil conductor 18a and the upstream end of the coil conductor 18b. The via-hole conductor v6 extends through the insulator layer 16f in the z-axis direction, and is connected to the downstream end of the coil conductor 18b and the upstream end of the coil conductor 18c. The via-hole conductor v7 extends through the insulator layer 16g in the z-axis direction, and is connected to the downstream end of the coil conductor 18c and the upstream end of the coil conductor 18d. The via-hole conductor v8 extends through the insulator layer 16h in the z-axis direction, and is connected to the downstream end of the coil conductor 18d and the upstream end of the coil conductor 18e.

The connecting conductor 22a is provided on the top surface S1, or first outermost surface of the multilayer body 12 (i.e., front surface of the insulator layer 16a) so as not to be in contact with the side surfaces S3 to S6 of the multilayer body 12 (i.e., outer edges of the insulator layer 16a). The shape of the connecting conductor 22a may be the same as the shape of any of the coil conductors 18a to 18e. In the present embodiment, the shape of the connecting conductor 22a is the same as the shape of the coil conductors 18b and 18d.

The connecting conductor 22b is provided on the bottom surface S2, or second outermost surface of the multilayer body 12 (i.e., back surface of the insulator layer 16m) so as not to be in contact with the side surfaces S3 to S6 of the multilayer body 12 (i.e., outer edges of the insulator layer 16m). The shape of the connecting conductor 22b may be the same as the shape of any of the coil conductors 18a to 18e. In the present embodiment, the shape of the connecting conductor 22b is the same as the shape of the coil conductors 18b and 18d.

As illustrated in FIG. 1, the outer electrode 14a is provided so as to cover the connecting conductor 22a by covering the entire area of the top surface S1 of the multilayer body 12. The outer electrode 14b is provided so as to cover the connecting conductor 22b by covering the entire area of the bottom surface S2 of the multilayer body 12. The outer electrodes 14a and 14b are folded from the top and bottom surfaces S1 and S2, respectively, so that the outer electrodes 14a and 14b are also provided on parts of the side surfaces S3 to S6.

The via-hole conductors v1 to v4 extend through the insulator layers 16a to 16d, respectively, in the z-axis direction and are connected to each other, thereby forming a single via-hole conductor. An end portion of the via-hole conductor v1 on the positive side in z-axis direction is connected to the connecting conductor 22a, as illustrated in FIG. 2. An end portion of the via-hole conductor v4 on the negative side in the z-axis direction is connected to the end portion A1. Thus, the via-hole conductors v1 to v4 connect the end portion A1 and the connecting conductor 22a to each other.

As illustrated in FIG. 2, the via-hole conductors v9 to v13 extend through the insulator layers 16i to 16m, respectively, in the z-axis direction and are connected to each other, thereby forming a single via-hole conductor. An end portion of the via-hole conductor v9 on the positive side in z-axis direction is connected to the end portion A2. An end portion of the via-hole conductor v13 on the negative side in the z-axis direction is connected to the connecting conductor 22b. Thus, the via-hole conductors v9 to v13 connect the end portion A2 and the connecting conductor 22b to each other.

An exemplary method for producing the electronic component 1 having the above-described structure will now be described with reference to FIG. 2. In the following description, a method for producing a single multilayer body 12 will be explained. However, in practice, a mother multilayer body in which a plurality of multilayer bodies 12 arranged in a matrix is produced, and is then cut so as to separate the multilayer bodies 12 from each other.

First, ceramic green sheets to be formed into the insulator layers 16 are prepared. Specifically, ferric oxide (Fe₂O₃), zinc oxide (ZnO), nickel oxide (NiO), and copper oxide (CuO) in a certain weight ratio are prepared as raw materials and subjected to wet mixing in a ball mill. The thus-obtained mixture is dried and ground into powder, which is then calcined at 800° C. for one hour. The calcined powder is subjected to wet grinding in a ball mill, dried, and then disintegrated to obtain ferrite ceramic powder.

The ferrite ceramic powder is mixed with a binder (e.g., vinyl acetate or water-soluble acrylic) a plasticizer, a humectant, and a dispersant in a ball mill. Then, defoaming is performed by reducing pressure. Subsequently, the defoamed mixture is formed into the shape of a sheet on a carrier sheet and dried by a doctor blade method. Thus, each of the ceramic green sheets is produced. The thickness of the ceramic green sheets can be, for example, 10 to 15 μm.

Next, the via-hole conductors v1 to v13 are formed in the ceramic green sheets to be formed into the insulator layers 16a to 16m, respectively. Specifically, via holes are formed in the ceramic green sheets to be formed into the insulator layers 16a to 16m by irradiating the ceramic green sheets with a laser beam. Subsequently, the via holes are filled with a paste made of a conductive material such as Ag, Pd, Cu, Au, or an alloy thereof by, for example, a printing method. Thus, the via-hole conductors v1 to v13 are formed.

Next, the coil conductors 18a to 18e are formed on the ceramic green sheets to be formed into the insulator layers 16e to 16i, respectively, by applying a paste made of a conductive material to the ceramic green sheets by, for example, screen printing or photolithography. The paste made of a conductive material is obtained by, for example, adding a varnish and a solvent to Ag.

The connecting conductor 22a is formed on the front surface of the ceramic green sheet to be formed into the insulator layer 16a by applying a paste made of a conductive material to the front surface of the ceramic green sheet by, for example, screen printing or photolithography. The paste made of a conductive material is obtained by, for example, adding a varnish and a solvent to Ag. The connecting conductor 22a does not cross any of the cut lines used to separate the multilayer bodies 12 from each other. The connecting conductor 22a is formed in the same shape as the shape of any of the coil conductors 18a to 18e.

The process of forming the coil conductors 18 (i.e., coil conductors 18a to 18e) and the connecting conductor 22a and the process of filling the via holes with a paste made of a conductive material (Ag or Ag—Pt) may be performed in the same step.

Next, the ceramic green sheets to be formed into the insulator layers 16a to 16m are stacked and pressure-bonded together so as to be arranged in that order from the positive side to the negative side in the z-axis direction. Thus, a green mother multilayer body is formed. Specifically, the ceramic green sheets are stacked and temporarily pressure-bonded one at a time. Subsequently, the mother multilayer body is subjected to permanent pressure bonding by isostatic pressing. The isostatic pressing is performed at a pressure of 100 MPa and a temperature of 45° C.

Subsequently, the connecting conductor 22b is formed on the back surface of the ceramic green sheet to be formed into the insulator layer 16m by printing or transferring. The connecting conductor 22b does not cross any of the cut lines used to separate the multilayer bodies 12 from each other. The connecting conductor 22b is formed in the same shape as the shape of any of the coil conductors 18a to 18e.

Next, the green mother multilayer body is cut so as to separate the green multilayer bodies 12 from each other. Specifically, the green mother multilayer body is cut with a dicer or the like.

Next, the surfaces the multilayer bodies 12 are subjected to chamfering by barrel polishing. After that, the green multilayer bodies 12 are subjected to debinding and firing processes. The debinding process is performed in, for example, a low oxygen atmosphere at about 500° C. for two hours. The firing process is performed, for example, at 870° C. to 900° C. for 2.5 hours.

Next, an electrode paste made of a conductive material that contains, for example, Ag as a main component is applied to the top surface S1, the bottom surface S2, and parts of the side surfaces S3 to S6 of each multilayer body 12. The applied electrode paste is baked at about 800° C. for one hour. Thus, a silver electrode to be included in the outer electrode 14 is formed. The outer electrode 14 is formed by performing Ni—Sn plating on the surface of the silver electrode. The electronic component 1 is completed through the above-described steps.

According to the electronic component 1, connection reliability between the coil L and the outer electrode 14a can be increased as described below. The electronic component 1 differs from the multilayer inductor 500 of Patent Document 1 in that the connecting conductor 22a is provided on the top surface S1 of the multilayer body, as illustrated in FIG. 2. In the multilayer inductor 500, an end portion of the connecting conductor 511a is directly connected to the outer electrode 509a. In contrast, in the electronic component 1, an end portion of the via-hole conductor v1 is connected to the connecting conductor 22a, and the connecting conductor 22a is connected to the outer electrode 14a. Owing to the above-described difference, disconnection between the via-hole conductor v1 and the outer electrode 14a is less likely to occur in the electronic component 1 than in the multilayer inductor 500, as described below.

In the multilayer inductor 500, the outer electrode 509a is formed after the multilayer body 503 is subjected to firing and barrel polishing. In other words, the outer electrode 509a and the connecting conductor 511a are formed in different steps. Therefore, there is a risk that the outer electrode 509a cannot be sufficiently connected to the connecting conductor 511a when the outer electrode 509a is formed. As a result, disconnection between the outer electrode 509a and the connecting conductor 511a easily occurs. In particular, the connecting conductor 511a and the outer electrode 509a are connected to each other in an area in which the connecting conductor 511a is exposed at an end surface of the multilayer body 503. Therefore, the connecting area is relatively small. As a result, disconnection between the outer electrode 509a and the connecting conductor 511a particularly easily occurs.

In contrast, the connecting conductor 22a is formed immediately after the via-hole conductor v1 is formed or together with the via-hole conductor v1. Therefore, the possibility of disconnection between the connecting conductor 22a and the via-hole conductor v1 is lower than that of disconnection between the outer electrode 509a and the connecting conductor 511a. In addition, in the electronic component 1, the outer electrode 14a is connected to the connecting conductor 22a. Since the connecting conductor 22a is a conductive layer, the contact area between the connecting conductor 22a and the outer electrode 14a is relatively large. Therefore, the possibility of disconnection between the outer electrode 14a and the connecting conductor 22a is extremely low. Accordingly, disconnection between the coil L and the outer electrode 14a is less likely to occur in the electronic component 1 than in the multilayer inductor 500. In other words, connection reliability between the coil L and the outer electrode 14a of the electronic component 1 can be increased. For a similar reason, connection reliability between the coil L and the outer electrode 14b of the electronic component 1 can also be increased.

As illustrated in FIG. 2, each of the connecting conductors 22a and 22b has the same shape as the shape of any of the coil conductors 18. Therefore, the connecting conductors 22a and 22b may be formed by using the same screen, photomask, etc., as those used to form the coil conductors 18. As a result, the manufacturing cost of the electronic component 1 can be reduced.

As illustrated in FIG. 2, the coil conductors 18 and the connecting conductors 22a and 22b are not in contact with the side surfaces S3 to S6 of the multilayer body 12. Thus, in the mother multilayer body, the connecting conductors 22a and 22b are not formed so as to cross any of the cut lines. Therefore, when the mother multilayer body is cut to separate the multilayer bodies 12 from each other, it is not necessary to cut the connecting conductors 22a and 22b, which are harder than the ceramic green sheets. As a result, degradation of a blade of a dicer or the like used to cut the mother multilayer body can be suppressed.

Since the coil conductors 18 and the connecting conductors 22a and 22b are not in contact with the side surfaces S3 to S6, the occurrence of defects such as delamination and cracks between the insulator layers 16 can be reduced.

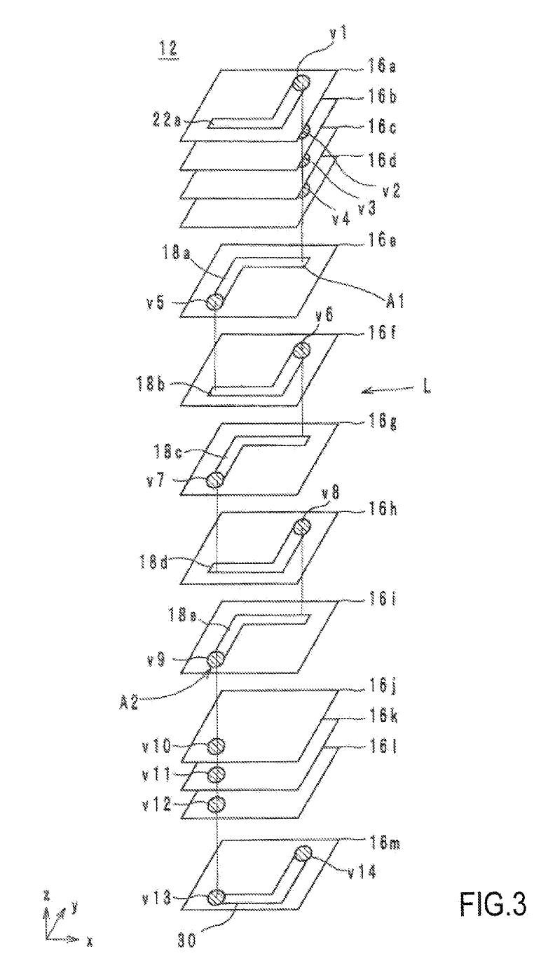

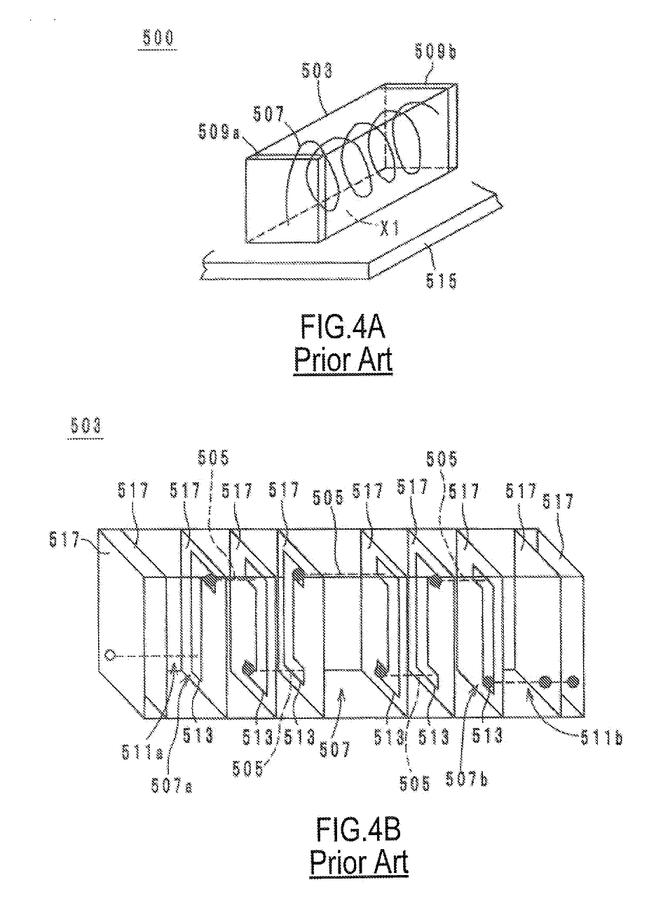

The electronic component 1 having the above-described structure is not limited to the above exemplary embodiment, and can be modified within the scope thereof. FIG. 3 is an exploded perspective view of a multilayer body 12 included in an electronic component 1 according to an exemplary modification.

As in the electronic component 1 illustrated in FIG. 3, a wiring conductor 30 may be provided on the front surface of the bottommost insulator layer 16m of the multilayer body 12, and via-hole conductors v13 and v14 may be provided so as to extend through the insulator layer 16m in the z-axis direction. The shape of the wiring conductor 30 is the same as the shape of any of the coil conductors 18a to 18e. In the present embodiment, the shape of the wiring conductor 30 is the same as the shape of the coil conductors 18b and 18d. The wiring conductor 30 and the outer electrode 14b are electrically connected to each other by two via-hole conductors v13 and v14 that extend through the insulator layer 16m in the stacking direction. Thus, the outer electrode 14b and the coil L are connected to each other at two locations by the via-hole conductors v13 and v14. In other embodiments, more than two via-hole conductors can be formed to extent through the insulator layer 16m in the stacking direction.

The electronic component 1 may instead be structured such that neither the wiring conductor 30 nor the connecting conductor 22b is provided on the insulator layer 16m.

What is claimed is:

1. An electronic component comprising:
a multilayer body having first and second outermost surfaces and including a plurality of insulator layers that are stacked together and having first and second surfaces that oppose each other in a stacking direction and side surfaces that connect the first and second surfaces to each other;
a coil incorporated in the multilayer body;
a first connecting conductor on the first outermost surface of the multilayer body and not in contact with the side surfaces of the multilayer body;
a first outer electrode on the first outermost surface of the multilayer body and covering the first connecting conductor; and
a first via-hole conductor connecting one end portion of the coil and the first connecting conductor to each other and extending through at least one of the insulator layers in the stacking direction.

2. The electronic component according to claim 1,
wherein the coil has a helical shape formed by a plurality of coil conductors provided on the insulator layers and a second via-hole conductor that extends through at least one of the insulator layers in the stacking direction, and
wherein a shape of the first connecting conductor is the same as a shape of any of the coil conductors.

3. The electronic component according to claim 2, further comprising:
a second connecting conductor provided on the second outermost surface of the multilayer body so as not to be in contact with the side surfaces of the multilayer body;
a second outer electrode provided on the second outermost surface of the multilayer body and covering the second connecting conductor; and
a third via-hole conductor connecting the other end portion of the coil and the second connecting conductor to each other and extending through at least one of the insulator layers in the stacking direction.

4. The electronic component according to claim 1, further comprising:
a wiring conductor provided on one of the insulator layers included in the multilayer body having the second outermost surface;
a second outer electrode provided on the second outermost surface of the multilayer body; and
two or more second via-hole conductors that are provided so as to electrically connect the second outer electrode and the wiring conductor to each other and extend through the insulator layer having the second outermost surface in the stacking direction.

5. The electronic component according to claim 2, further comprising:
a wiring conductor provided on one of the insulator layers included in the multilayer body having the second outermost surface;
a second outer electrode provided on the second outermost surface of the multilayer body; and
two or more third via-hole conductors that are provided so as to electrically connect the second outer electrode and the wiring conductor to each other and extend through the insulator layer having the second outermost surface in the stacking direction.

6. The electronic component according to claim 1,
wherein the coil has a helical shape whose central axis extends in the stacking direction.

7. The electronic component according to claim 2,
wherein the coil has a helical shape whose central axis extends in the stacking direction.

8. The electronic component according to claim 3,
wherein the coil has a helical shape whose central axis extends in the stacking direction.

9. The electronic component according to claim 4,
wherein the coil has a helical shape whose central axis extends in the stacking direction.

10. The electronic component according to claim 5,
wherein the coil has a helical shape whose central axis extends in the stacking direction.

11. A method for producing the electronic component according to claim 2, the method comprising:
preparing the insulator layers;
forming the first and second via-hole conductors in the insulator layers;
forming the coil conductors and the first connecting conductor on the insulator layers;
stacking the insulator layers in and on which the first via-hole conductor, the second via-hole conductor, the coil conductors, and the first connecting conductor are formed to form the multilayer body; and
forming the first outer electrode on the multilayer body.
